(19) United States
(12) Patent Application Publication
(10) Pub. No.: US 2007/0241618 A1
(43) Pub. Date: Oct. 18, 2007

(54) Intelligent Battery Switching Circuit Block for Portable Devices

(76) Inventor: Cai Gang Xu, Singapore (SG)

Correspondence Address: DICKSTEIN SHAPIRO LLP, 1825 EYE STREET NW, Washington, DC, 20006-5403, US

(21) Appl. No.: 10/592,374

(22) PCT Filed: Feb. 28, 2005
(86) PCT No.: PCT/SG05/00059

§ 371 Date: Sep. 11, 2006

(30) Foreign Application Priority Data
Mar. 18, 2004 (SG) 200401468-4

(51) Int. Cl. H02J 7/00

(52) U.S. Cl. 307/80

(57) ABSTRACT

The present invention provides an intelligent battery switching circuit block for a portable device comprising a comparator which compares the voltages of a main battery and an external battery and which outputs a HIGH or LOW indication of the result of the comparison; and a circuit for selecting the main battery as the power source for the portable device when the indication of the result of the comparison toggles between LOW and HIGH values. The switching circuit block includes a pair of mechanical switches that are closed before insertion of the external battery and which are open when the external battery is inserted into the portable device.

### FIELD OF THE INVENTION

The present invention relates to battery powered portable devices and more particularly to circuits for switching between several battery power supplies in battery powered portable devices.

### BACKGROUND OF THE INVENTION

In prior-art devices it is known to switch between several battery power supplies. These devices require that when a main battery (e.g. internal battery) runs out or is going to run out, the system will indicate that the user should change to an external battery or power supply. However, in prior-art devices, disruption of device operation can occur when switching between power sources.

To solve this problem, it would be desirable to provide an intelligent battery switching circuit block that could detect whether an external battery has enough power after it is plugged in to the device. In order to maximize the run time of the battery it would be desirable to power the device with the battery which has higher remaining power. It would also be desirable to avoid inter-charge between the external and main (internal) batteries.

### SUMMARY OF THE INVENTION

The present invention provides an intelligent battery switching circuit block for portable devices to solve the problems of the prior art. The present invention prevents inter-charging between the external and main (internal) batteries. It also provides a robust indication if the external battery is inserted and which battery is in use. Additionally, no disturbance of the device operation occurs during switching between power sources. These goals are achieved without using large energy storage components, such as capacitors, inductors, etc. The invention also allows a user to select either the external or main battery as the device that is preferred for use. The invention provides for robust mechanical insertion and removal of the external battery.

In particular, the present invention provides an intelligent battery switching circuit block for a portable device comprising a comparator which compares the voltages of a main battery and an external battery and which outputs a HIGH or LOW indication of the result of the comparison. A sub-circuit is included for selecting the main battery as the power source for the portable device when the indication of the result of the comparison toggles between LOW and HIGH values. The switching circuit block includes a pair of mechanical switches that are closed before insertion of the external battery and which are open when the external battery is inserted into the portable device.

The circuit block selects the external battery for supplying power to the portable device when result of the comparison shows that the voltage of the external battery is greater than the voltage of the main battery, in particular when it is greater by a threshold voltage value.

A NAND-gate has a first NAND-gate input electrically connected to the comparator output and also has a second NAND-gate input. A multiplexer supplies power to the portable device from either the main battery or the external battery in response to an output from the NAND-gate. The NAND-gate enters a lock mode upon receiving the toggling comparator output at the first NAND-gate input and receiving the first logic level at the second NAND-gate input. The lock mode causes the NAND-gate to output the second logic level irrespective of the input to the first NAND-gate input. The multiplexer supplies power to the portable device from the main battery in response to the second logic level output from the NAND-gate.

The sub-circuit includes a flip-flop, the flip-flop has an output electrically connected to the second NAND-gate input and receives as an input an indication of the toggling comparator output. In response to the indication, it outputs to the NAND-gate input the second logic level irrespective of the input to the first NAND-gate input.

An output from the NAND-gate indicates whether the main battery or the external battery is to be selected to power the device.

In one embodiment the flip-flop is a D flip-flop including a grounded data input, a clock input and a preset pin. The flip-flop switches to the second logic level corresponding to the grounded data input upon receiving a rising edge signal at the clock input indicating the toggling comparator output. The flip-flop remains at the second logic level until the preset pin is grounded.

First and second diodes connect the main and external batteries to the comparator and sub-circuit so that whichever one has the greater voltage supplies power to the comparator and sub-circuit for operation of the intelligent battery switching circuit block.

A first mechanical switch is electrically connected to the preset pin. The first mechanical switch is closed when the external battery is removed from the portable device and opened when the external battery is inserted into the portable device. Also, the preset pin is pulled to ground when the mechanical switch is closed.

A second mechanical switch directly connects the main battery to the external battery so that power is supplied to the portable device from the main battery until the external battery is fully inserted into the portable device in order to prevent toggling of the comparator output during insertion of the external battery. The second mechanical switch is opened when the external battery is fully inserted into the portable device.

The first and second mechanical switches are opened simultaneously by a commonly shared trigger upon insertion of the external battery into the portable device.

A user selected input can be used to force the battery switching circuit block to use the external battery to supply power to the device.

### BRIEF DESCRIPTION OF THE FIGURES

Further preferred features of the invention will now be described for the sake of example only with reference to the following figures, in which:

FIG. 1 shows the Intelligent Battery Switching Circuit Block for Portable Devices of the present invention.

FIG. 2 shows the operation of the mechanical switches of the circuit of FIG. 1.

FIG. 3 shows an exemplary signal timing diagram for the circuit of FIG. 1.

### DETAILED DESCRIPTION OF THE EMBODIMENTS

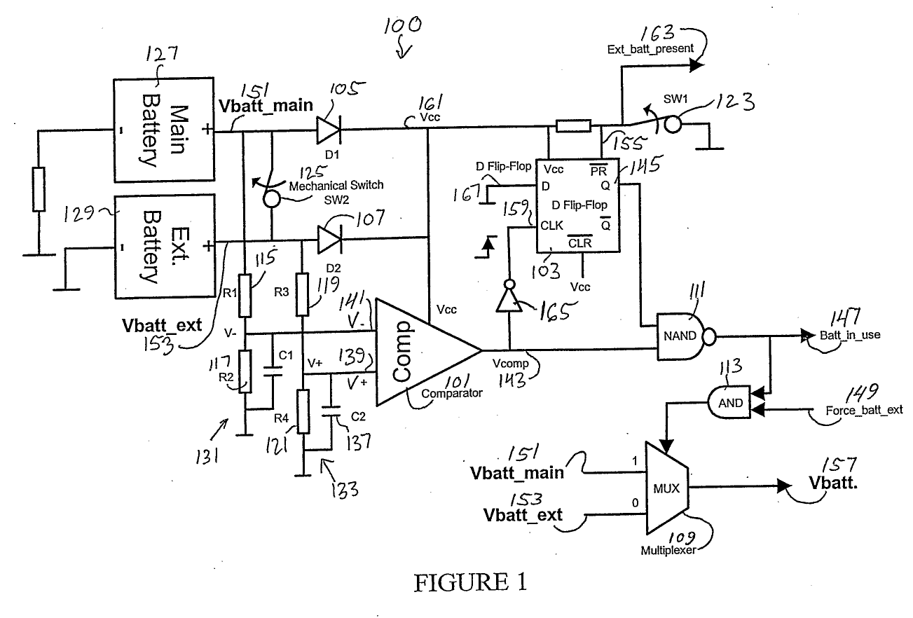

The intelligent battery switching circuit block 100 of the present invention is illustrated in FIG. 1. The circuit block 100 can be used in a portable battery powered device for switching between a main battery 127 and an external battery 129 when the main battery 127 reaches a low power condition. The circuit includes a comparator 101, a D Flip-flop 103, diodes D1 105 and D2 107, an inverter 165, an analog multiplexer 109, a NAND gate 111, an AND gate 113, resistors R1 115, R2 117, R3 119, R4 121 along with capacitors C1 135, C2 137 forming a pair of voltage dividers 131, 133 and a pair of mechanical switches SW1 123 and SW2 125. The main battery 127 and the external battery 129 are shown connected to the switching circuit 100 for supplying the voltages Vbatt_main 151 and Vbatt_ext 153.

The comparator 101 determines which of the batteries 127, 129 has the greater charge by comparing input voltages V+ 139 and V− 141 to obtain the output voltage Vcomp 143. If the voltage V+ 139 is higher than the voltage V− 141 than the output Vcomp 143 becomes 1 (HIGH). Otherwise the output Vcomp 143 becomes 0 (LOW). The input voltage V+ 139 is delivered by the voltage divider 133 from the external battery 129. The input voltage V− 141 is delivered by the voltage divider 131 from the main battery 127. The values for the voltage divider components are selected so that if the external battery voltage Vbatt_ext 153 is at least some threshold voltage value ΔV (e.g. 0.25V) higher than the output from the main battery, the comparator outputs HIGH to the NAND gate 111 (i.e. if Vbatt_ext−Vbatt_main≧ΔV). Conversely, if the external battery voltage is less than 0.25V higher than the output from the main battery, the comparator outputs LOW to the NAND gate 111 (i.e. if Vbatt_ext−Vbatt_main<ΔV).

The values of the components forming the voltage dividers 131, 133 should be chosen so as to compromise between impedance matching and current consumption. In order to provide good impedance matching between the resistors and the inputs to the comparator 101, it is desirable to make the sums of the values of the resistors R1+R2 and R3+R4 small. However, the smaller the values of these sums the more current will be consumed because the current through the voltage divider 131 is Vbatt_main/(R1+R2) and the current through the voltage divider 133 is Vbatt_ext/(R3+R4). The capacitors C1 135 and C2 137 are for reducing electrical noise.

The output voltage Vcomp 143 from the comparator 101 is used to select which of the batteries is to serve as the power source. The NAND gate 111 receives the output voltage Vcomp 143 as one input and receives a signal Q 145 from the D Flip-flop 103 as another input.

The D flip-flop 103 has two inputs, a data input D 167 and a clock input CLK 159. It also has complementary outputs, the output Q 145 and an output Q̅. Also shown is a preset pin P̅R̅ 155 and inputs for receiving the Vcc power supply. When the clock is low, the flip-flop is in the memory, or rest, state. As the clock goes high, the flip-flop acquires the logic level that existed on the D line 167 just before the rising edge of the clock. In the present embodiment, D is grounded so that the flip-flop acquires the LOW logic level of the grounded D upon detection of the rising edge of the clock. Thus the flip-flop is edge-triggered. The flip-flop remains at this logic level until the preset pin P̅R̅ 155 is pulled to ground by closing the switch SW1 123.

During normal use of a portable battery powered device, the power will be supplied by the main battery 127. The power is supplied by the main battery 127 when the external battery 129 is not connected or when the main battery 127 supplies a voltage to V− 141 greater than the voltage V+ 139 that can be supplied by the external battery 129 (i.e. Vbatt_main>Vbatt_ext−ΔV). In these situations, the Vcomp 143 supplied to the D Flip-flop 103 is LOW. Also, the signal Q 145 provided by the D Flip-flop 103 has a HIGH value.

The value of the signal Q 145 provided by the D Flip-flop 103 is determined by the switch SW1 123 and a CLK input 159. When the external battery 129 is not inserted, then the switch SW1 123 connects the preset pin P̅R̅ 155 to ground to set the D Flip-flop 103 to its preset HIGH value of Q 145.

Similarly, the power will be supplied by the main battery 127 when the external battery 129 is connected to the switching circuit 100 but does not supply a voltage V+ 139 greater than the voltage V− 141 supplied by the main battery 127 (i.e. Vbatt_main>Vbatt_ext−ΔV). In this situation the Vcomp 143 supplied to the D Flip-flop 103 remains LOW.

The signal Q 145 provided by the D Flip-flop 103 remains at a HIGH value when the external battery 129 is inserted into the switching circuit 100. When the external battery 129 is connected to the switching circuit 100 the switch SW1 123 is open and no longer connects the preset pin P̅R̅ 155 to ground. The D Flip-flop 103 still maintains its HIGH value for Q 145 since the insertion of the external battery 129 does not change the value of Vcomp 143 and thus there is no rising clock signal generated and input to the CLK input 159.

When the NAND gate 111 receives the LOW value for Vcomp 143 and the HIGH value for the signal Q 145, it will produce an output batt_in_use 147 which will have a HIGH value. The signal batt_in_use 147 is used to notify the device which battery is to be selected to power the device.

The signal batt_in_use 147 is also passed to the AND gate 113. The AND gate 113 receives another input force_batt_ext 149 which is normally set to a value of HIGH. Thus, the AND gate 113 passes to the multiplexer 109 the signal batt_in_use 147 having a HIGH value in the present example. This HIGH value input to the multiplexer 109 causes the multiplexer to supply the main battery voltage Vbatt_main 151 as a voltage Vbatt 157 for supplying power to the device.

The multiplexer 109 supplies the voltage Vbatt_main 151 to the device as the voltage Vbatt 157 when the multiplexer control voltage is HIGH and supplies the voltage Vbatt_ext 153 to the device as the voltage Vbatt 157 when the multiplexer control voltage is LOW. In one embodiment the current limit of the multiplexer 109 is 3A and the switching time is less than 5 nanoseconds. Assuming for such an embodiment that:

a) all power supply lines for each IC are decoupled to the ground with capacitors having values of C=100 nF;

b) the allowed voltage drop ΔV is 1% during switching, which is 0.033V when the supply is 3.3V; and

c) the maximum current consumption I for each IC is 500 mA;

then the acceptable maximum switching time can be calculated as:

$$Δ t = \frac{Δ V \times C}{I} = \frac{0.033 \times 100 \times {10}^{- 9}}{500 \times {10}^{- 3}} = 6.6 \times {10}^{- 9} sec$$

In the case where a fully charged external battery 129 is connected to the switching circuit 100 (or at least an external battery 129 satisfying Vbatt_ext≧Vbatt_main+ΔV), the switching circuit 100 will change-over to using the Vbatt_ext 153 to supply the Vbatt 157. In this situation, because Vbatt_ext−Vbatt_main≧ΔV, the comparator 101 will output a HIGH value for Vcomp 143 to the NAND gate 111.

In this case, the signal Q 145 provided by the D Flip-flop 103 still has a HIGH value. When the external battery 129 is connected to the switching circuit 100 the switch SW1 123 is open and no longer connects the preset pin P̅R̅ 155 to ground. However, the D Flip-flop 103 still maintains its HIGH value for Q 145 since the insertion of the external battery 129 results in a rising pulse Vcomp 143 which is inverted by the inverter 165 into a falling pulse input to the CLK 159. The value of Q 145 changes to LOW when a rising pulse is input to the CLK 159, not when a falling pulse is input to the CLK 159.

When the NAND gate 111 receives the HIGH value for Vcomp 143 and the HIGH value for the signal Q 145, it will produce an output batt_in_use 147 which has a LOW value.

The signal batt_in_use 147 is then passed to the AND gate 113. The AND gate 113 receives the input force_batt_ext 149 which is normally set to a value of HIGH. Thus, the AND gate 113 passes to the multiplexer 109 the signal batt_in_use 147 having a LOW value in the present example. This LOW value input to the multiplexer 109 causes the multiplexer to supply the external battery voltage Vbatt_ext 153 as the voltage Vbatt 157 for supplying power to the device.

In another situation, the external battery 129 is discharged to a level such that it supplies a voltage V+ 139 approximately equal to the voltage V− 141 supplied by the main battery 127 (i.e. Vbatt_main Vbatt_ext−ΔV). This can occur when the external battery 129 is in a discharged state when connected to the switching circuit 100 or can occur after the device has been using the external battery 129 for some time thereby discharging the external battery 129 to the level where Vbatt_ext ≅Vbatt_main+ΔV. In this situation it might be expected that the output of the comparator would begin toggling between outputting Vcomp 143 having HIGH and LOW values. This could cause the possible loss of data and the disturbance of system operation if not for the inventive features of the present invention. In the present invention, when the difference between Vbatt_ext 153 and Vbatt_main 151 changes from greater than the threshold voltage ΔV to less than the threshold voltage ΔV, the value of Vcomp 143 will change from 1 to 0 (HIGH to LOW). Therefore, after the inversion of Vcomp 143 by the inverter 165, a rising edge is input to the CLK pin 159 of the D Flip-flop 145. This rising edge of the CLK input results in the output Q 145 of the D Flip-flop 145 changing to “0” (LOW). Once the value of the D Flip-flop 145 becomes LOW (Q=0), it will remain LOW unless the preset pin P̅R̅ 155 is again pulled to ground by removing the external battery 129 to close the switch SW1 123, or by using software to force P̅R̅ to be LOW. When Q 145 is LOW, the NAND gate 111 is disabled or blocked. Thus, the output from the NAND gate 111 is HIGH regardless of the value of Vcomp 143. In this way, the toggling problem is prevented by supplying the power from the main battery whenever the external battery 129 is at a low charge level such that Vbatt_ext≅Vbatt_main+ΔV.

As can be seen from the above description, the NAND gate 111 can be said to be disabled or enabled by the output Q 145 of the D Flip-flop 103. When Q=1 (HIGH), the NAND gate 111 is enabled and the output of the NAND gate 111 is determined by the value of Vcomp 143 (i.e. Batt_in_use= V̅c̅o̅m̅p̅). When Q=0 (LOW), the NAND gate 111 is disabled or blocked. Thus, the output from the NAND gate 111 is (1) HIGH regardless of the value of Vcomp 143. This mode can be called the “Lock-Mode”. The circuit can exit the “Lock-Mode” if the external battery 129 is removed so that the switch 123 is closed and the preset pin P̅R̅ 155 is again pulled to ground. Alternatively, a HIGH signal Forec_batt_ext 149 can be used to force the multiplexer to 109 to select the external battery 129.

Before inserting the external battery in the examples above, the switch SW1 123 is closed to ground. This presets the D Flip-flop to Q=1 (HIGH) thereby enabling the NAND gate 111. After insertion of the external battery 129, the switch SW1 123 opens, and as long as there is no toggling of the voltage Vcomp 143, the value of the output Q 145 will remain HIGH.

FIG. 1 also shows the diode D1 105 is connected to the main battery 127 and the diode D2 107 is connected to the external battery 129. This diode arrangement results in the battery with the higher voltage supplying power to the other components of the battery switching circuit 100. The diodes also prevent inter-charging between the two batteries. The voltage drop across each of the diodes is typically about 0.35V.

The battery switching circuit 100 is able to maintain reliable power flow for its own operation even when the external battery 129 is inserted having low charge or when the external battery 129 supplying power to the device becomes discharged to the point where it supplies less voltage than the main battery 127. As shown in FIG. 1, a voltage Vcc 161 is supplied to power the battery switching circuit 100, and in particular to power the comparator 101 and the D Flip-flop 103. The voltage Vcc 161 in turn is supplied by either the main battery 127 or the external battery 129, whichever has the greater voltage after passing across the voltage drop of the diodes 105 and 107 (for example a 0.35V voltage drop), respectively. Thus the voltage Vcc 157 is given by Vcc=Max(Vbatt_main, Vbatt_ext)−0.35V. In this way there is no interruption to the operation of the battery switching circuit 100.

In the present invention, it is important to prevent bouncing effects that can occur when the external battery 129 is inserted into the battery switching circuit 100 of the device. The bouncing effect is particularly disruptive in the present invention as they can cause the D Flip-flop 145 to go into an unwanted “Lock Mode”. As described above, the “Lock Mode” is intended to lock the NAND gate 111 to select the main battery 127 as the power source whenever the main battery 127 and external battery 129 have values close enough to cause toggling between the HIGH and LOW Vcomp 143 output of the comparator 101. The unwanted “Lock Mode” can occur because as the external battery 129 is inserted, the battery contacts can repeatedly become connected and disconnected (“bounce”) with the corresponding device contacts. Thus it can appear that the voltage of the external battery 129 is switching between values higher than and lower than the voltage of the main battery 127. The Vcomp 143 output of the comparator 101 thus toggles between the HIGH and LOW values, causing a rising edge of the CLK 159 and a LOW output Q 145 of the D Flip-flop 145. Once the value of the D Flip-flop 145 becomes LOW, it will remains LOW unless the preset pin P̅R̅ 155 is again pulled to ground by removing the external battery 129. The result of the bouncing effect is that it is very difficult to insert the external battery 129 without activating the “Lock Mode” which prevents the power from being supplied to the device by the external battery 129.

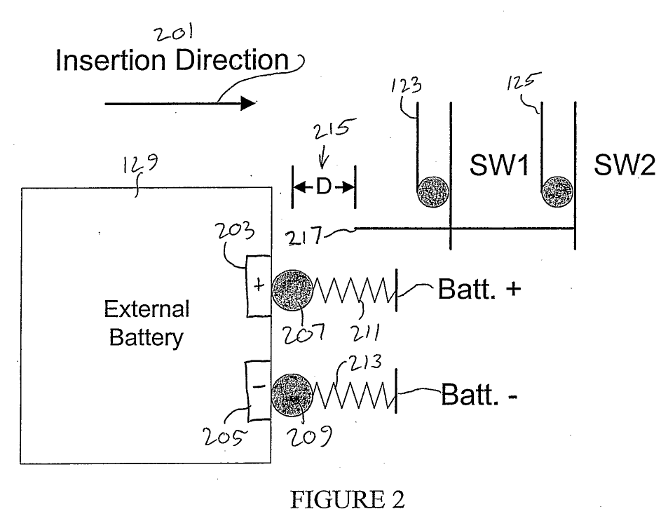

The present invention uses the mechanical switches 123 and 125 illustrated in FIG. 2 to prevent the bouncing effect that can occur when the external battery 129 is inserted into the battery switching circuit 100 of the device. In one embodiment, the switches SW1 123 and SW2 125 can use currents of 4 mA and 2 A, respectively. As the external battery 129 is inserted into the device in the insertion direction 201, positive (+) 203 and negative (−) 205 leads of the battery contact positive (+) 207 and negative (−) leads 209 of the device. The positive (+) 207 and negative (−) leads 209 of the device include tension members 211, 213 which push the battery and device leads together with an elastic force as the external battery 129 is inserted a distance “D” 215. It is not until the leads are firmly contacting that the battery pushes a mechanical trigger 217 located at the distance “D” 215 and which in turn simultaneously opens the switches SW1 123 and SW2 125. Similarly, when the external battery is removed from the device, the mechanical trigger 217 simultaneously releases the switches SW1 123 and SW2 125 so that they close before the external battery is disconnected from the device.

A useful distance “D” 215 can be estimated for a particular embodiment. If, for example, the maximum insertion velocity of the external battery 129 is 200 mm/s, and the settling time for the battery switching circuit is 10 ms, then the distance “D” 215 should be at least 2 mm.

Before the switches SW1 123 and SW2 125 are opened, the main battery 127 and the external battery 129 are shorted together through the switch SW2 125. Although the NAND gate 111 is enabled with the preset pin P̅R̅ 155 pulled to ground, because Vbatt_ext−Vbatt_main=0, Vbatt_ext−Vbatt_main<ΔV and the output of the comparator Vcomp 143 remains LOW regardless of any bouncing. Thus, during any bouncing that might occur when inserting the external battery 129, the power supply remains fixed to the main battery 127 without the NAND gate 111 entering the “Lock Mode”. Once the switches SW1 123 and SW2 125 are opened, no bouncing effects occur because the leads 203 and 205 are firmly contacting the leads 207 and 209.

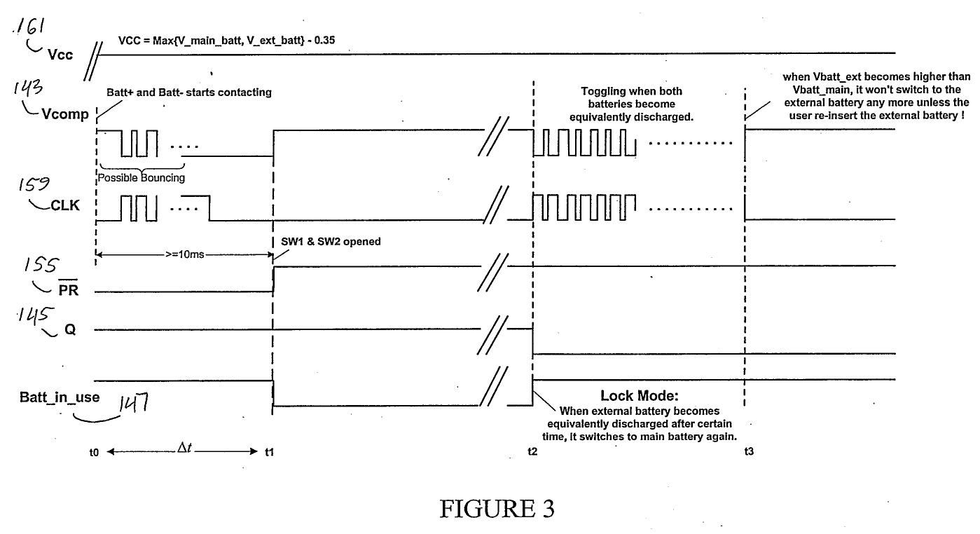

FIG. 3 shows an exemplary signal timing diagram for the switching circuit 100 for the situation when initially the external battery 129 supplies to the comparator 101 a voltage higher than that supplied by the main battery 127 (i.e. Vbatt_ext>Vbatt_main+ΔV). FIG. 3 is explained with reference to the reference numerals of FIGS. 1 and 2. The voltage Vcc 161 is first supplied to the switching circuit 100 by the main battery 127. At time t=t0, the external battery 129 is first inserted into the battery switching circuit 100 and makes contact with the leads 207 and 209. The switches SW1 123 and SW2 125 remain closed until the external battery 129 has been inserted into the battery switching circuit 100 a distance “D” 215 during a time t1=t0+Δt, at which time the mechanical trigger 217 is triggered by the external battery. Here Δt is the time it takes for the external battery 129 to travel the distance “D” 215 and can be chosen to be at least 10 ms as calculated above.

Also shown in the figure is the toggling of Vcomp 143 and the rising edge CLK signals 159 input to the D Flip-flop 103 that might result in “Lock-Mode” if not for the inventive mechanical switches SW1 123 and SW2 125 disclosed herein.

During interval Δt, before the switches SW1 123 and SW2 125 are opened, the main battery 127 and the external battery 129 are shorted together and thus the output of the comparator Vcomp 143 remains LOW. At the same time, the switch SW1 123 connects the preset pin P̅R̅ 155 to ground to set the D Flip-flop 103 to its preset HIGH value of Q 145.

At the time t=t1, the switches SW1 123 and SW2 125 are opened, so that Vbatt_main 151 and Vbatt_ext 153 are no longer shorted together and so that the preset pin P̅R̅ 155 is no longer grounded. The value of Q 145 remains at the preset HIGH level, since no rising edge CLK signals 159 occur. Also, the external battery 129 has a voltage higher than that of the main battery 127 by at least the threshold value ΔV, therefore the value of Vcomp 143 changes to high and simultaneously the battery supply is switched to the external battery 129 and the output signal batt_in_use 147 switches from indicating the battery in use as the main battery 127 to the external battery 129.

After the device has been running from the external battery 129 for some time, the external battery 129 can discharge to a level such that it supplies a voltage V+ 139 to the comparator 101 approximately equal to the voltage V− 141 supplied by the main battery 127 (i.e. Vbatt_ext≅Vbatt_main+ΔV). Thus, at the time t=t2, the “Lock Mode” occurs and the battery switching circuit 100 switches back to the main battery as shown by the output signal batt_in_use 147 provides an indication of the battery in use switching from the external battery 129 to the main battery 127.

At the time t=t3, the main battery 127 discharges until it is once again changed to a level Vbatt_main<Vbatt_ext+ΔV. However, at this point the circuit is already in the “Lock Mode” and won't switch back to the external battery 129 until the external battery 129 is re-inserted or optionally the preset pin P̅R̅ 155 is forced to be LOW by a software application in the device.

As shown in FIG. 1, the battery switching circuit 100 also includes an “external battery present” output Ext_batt_present 163. This signal comes from the mechanical switch SW1 123. If the external battery is inserted, the switch SW1 123 is open and Ext batt present 163 is HIGH. Otherwise, Ext_batt present 163 is LOW.

In the above, the value “1” is assigned to “HIGH” and the value “0” is assigned “LOW”. However, in the actual circuit particular voltages are assigned to “HIGH” and “LOW” as is understood by those skilled in the art. Also, more generally, these values can be referred to as “Logic Levels”. These “Logic Levels” can be represented by different voltages by different devices as long as the correspondence between voltages representing the same “Logic Levels” can be maintained. Moreover, there is a range of voltages that will be detected as the two logic levels, i.e. there is a range of voltages that will be detected as the “HIGH” voltage and a range of voltages that will be detected as the “LOW” voltage. The important thing is that the two ranges of voltages can be differentiated from each other so that one range can be identified as “HIGH” and one as “LOW”. Also, a circuit having “HIGH” and “LOW” reversed in the above description also falls within the scope of the invention since these are relative rather than absolute values.

The present invention is also not limited to a single main and external battery, but also works with various combinations of multiple external and/or main batteries.

Thus, although the invention has been described above using particular embodiments, many variations are possible within the scope of the claims, as will be clear to a skilled reader.

We claim:

1. A intelligent battery switching circuit block for a portable device comprising:
a comparator which compares voltages supplied from a main battery and an external battery and which outputs from a comparator output a first logic level or a second logic level indication of the result of the comparison; and
a sub-circuit for selecting the main battery as the power source for the portable device when the indication is a toggling comparator output which toggles between the first and second logic levels.

2. The intelligent battery switching circuit block for a portable device of claim 1, wherein the sub-circuit comprises:
a NAND-gate having a first NAND-gate input electrically connected to the comparator output and also has a second NAND-gate input;
a multiplexer supplying power to the portable device from either the main battery or the external battery in response to a logic output from the NAND-gate;
wherein the NAND-gate enters a lock mode upon receiving the toggling comparator output at the first NAND-gate input and receiving the first logic level at the second NAND-gate input, the lock mode causing the NAND-gate to output the second logic level irrespective of the input to the first NAND-gate input; and
the multiplexer supplying power to the portable device from the main battery in response to the second logic level output from the NAND-gate.

3. The intelligent battery switching circuit block for a portable device of claim 2, wherein the sub-circuit further comprises a flip-flop, the flip-flop having an output electrically connected to the second NAND-gate input, the flip-flop receiving as an input an indication of the toggling comparator output and in response outputting to the NAND-gate input the second logic level irrespective of the input to the first NAND-gate input.

4. The intelligent battery switching circuit block for a portable device of claim 3, wherein the flip-flop is a D flip-flop further comprising:
a grounded data input;
a clock input;
a preset pin; and wherein
the flip-flop switches to the second logic level corresponding to the grounded data input upon receiving a rising edge signal at the clock input indicating the toggling comparator output, the flip-flop remaining at the second logic level until the preset pin is grounded.

5. The intelligent battery switching circuit block for a portable device of claim 4, further comprising a first mechanical switch electrically connected to the preset pin, the first mechanical switch closed when the external battery is removed from the portable device and opened when the external battery is inserted into the portable device;
and wherein:
the preset is pulled to ground when the mechanical switch is closed.

6. The intelligent battery switching circuit block for a portable device of claim 1, wherein the circuit block selects the external battery for supplying power to the portable device when result of the comparison shows that the voltage of the external battery is grater than the voltage of the main battery.

7. The intelligent battery switching circuit block for a portable device of claim 1, wherein the circuit block selects the external battery for supplying power to the portable device when result of the comparison shows that the voltage of the external battery is greater than the voltage of the main battery by a threshold voltage value.

8. The intelligent battery switching circuit block for a portable device of claim 1, further comprising a first diode electrically connecting the main battery to the comparator and sub-circuit and a second diode electrically connecting the external battery to the comparator and sub-circuit so that the whichever one of the main battery and external battery has the greater voltage supplies power to the comparator and sub-circuit for operation of the intelligent battery switching circuit block.

9. The intelligent battery switching circuit block for a portable device of claim 1, further comprising a second mechanical switch for directly connecting the main battery to the external battery so that power is supplied to the portable device from the main battery until the external battery is fully inserted into the portable device in order to prevent toggling of the comparator output during insertion of the external battery and wherein the second mechanical switch is opened when the external battery is fully inserted into the portable device.

10. The intelligent battery switching circuit block for a portable device of claim 5, further comprising a second mechanical switch for directly connecting the main battery to the external battery so that power is supplied to the portable device from the main battery until the external battery is fully inserted into the portable device in order to prevent toggling of the comparator output during insertion of the external battery and wherein the second mechanical switch is opened when the external battery is fully inserted into the portable device;
and wherein the first and second mechanical switches are opened simultaneously by a commonly shared trigger upon insertion of the external battery into the portable device.

11. The intelligent battery switching circuit block for a portable device of claim 2, further comprising an output from the NAND-gate indicating whether the main battery or the external battery is to be selected to power the device.

12. The intelligent battery switching circuit block for a portable device of claim 2, further comprising an user selected input to force the battery switching circuit block to use the external battery to supply power to the device.
